(19) United States
(12) Patent Application Publication
(10) Pub. No.: US 2019/0266743 A1
(43) Pub. Date: Aug. 29, 2019

(54) OCCUPANT MONITORING APPARATUS

(71) Applicant: OMRON Corporation, Kyoto-shi (JP)

(72) Inventor: Yoshio MATSUURA, Komaki-shi (JP)

(73) Assignee: OMRON Corporation, Kyoto-shi (JP)

(21) Appl. No.: 16/260,228

(22) Filed: Jan. 29, 2019

(30) Foreign Application Priority Data
Feb. 27, 2018 (JP) 2018-033132

(51) Int. Cl. G06T 7/70; G06K 9/00; B60R 11/04; G06T 7/80

(52) U.S. Cl. CPC G06T 7/70; G06K 9/00838; B60R 2011/001; G06T 7/80; B60R 11/04

(57) ABSTRACT

An occupant monitoring apparatus for measuring the spatial position of an occupant predetermined site with a camera includes a camera capturing an image of a vehicle occupant, an image processor processing the captured image, and a position calculator calculating the spatial position of the occupant predetermined site using the processed image. The camera is installed on a steering wheel of the vehicle away from a rotational shaft to be rotatable together with the steering wheel. The image processor rotates two images captured at two positions by the camera rotated together with the steering wheel to generate rotated images. The position calculator calculates the spatial position of the occupant predetermined site using a linear distance between the two positions, a parallax obtained from the rotated images, and a focal length of the camera.

### CROSS-REFERENCE TO RELATED APPLICATION

This application claims priority to Japanese Patent Application No. 2018-033132 filed on Feb. 27, 2018, the entire disclosure of which is incorporated herein by reference.

### FIELD

The present invention relates to an occupant monitoring apparatus for monitoring an occupant with a camera installed in a vehicle, and particularly to a technique for measuring the spatial position of a predetermined site of the occupant.

### BACKGROUND

To perform predetermined vehicle control in accordance with a driver's face position, the spatial position of the face is detected in the vehicle. For example, the distance from a reference position (e.g., a camera position) to the face of the driver can differ between when the driver is awake and looking straight ahead and when the driver is falling asleep and has his or her head down. This distance can be detected as the driver's face position for determining whether the driver is awake or falling asleep. A vehicle incorporating a head-up display (HUD) system may detect the face position (in particular, eye position) of the driver for optimally displaying an image at the eye position in front of the driver's seat.

A driver monitor is known for detecting the face of a driver. The driver monitor monitors the driver's condition based on an image of the driver's face captured by a camera, and performs predetermined control, such as generating an alert, if the driver is falling asleep or engaging in distracted driving. The face image obtained by the driver monitor provides information about the face orientation or gaze direction, but contains no information about the spatial position of the face (the distance from a reference position).

The spatial position of the face may be measured by, for example, two cameras (or a stereo camera), a camera in combination with patterned light illuminating a subject, or an ultrasonic sensor. The stereo camera includes multiple cameras and increases the cost. The method using the patterned light involves a single camera, but uses a dedicated optical system. The ultrasonic sensor increases the number of components and increases the cost, and can further yield the distance with an end point indefinite in the subject, which is likely to deviate from the detection result of the driver monitor.

Patent Literature 1 describes a driver monitoring system including a camera installed on a steering wheel of a vehicle for correcting an image of a driver captured by a camera into an erect image based on the steering angle. Patent Literature 2 describes a face orientation detection apparatus for detecting the face orientation of a driver using two cameras installed on the instrument panel of a vehicle. However, neither Literature 1 or 2 describes techniques for measuring the face position with the camera(s) and responds to the above issue.

### CITATION LIST

### Patent Literature

Patent Literature 1: Japanese Unexamined Patent Application Publication No. 2007-72774

Patent Literature 2: Japanese Unexamined Patent Application Publication No.

2007-257333

### SUMMARY

### Technical Problem

One or more aspects of the present invention are directed to an occupant monitoring apparatus that measures the spatial position of a predetermined site of an occupant with a single camera.

### Solution to Problem

The occupant monitoring apparatus according to one aspect of the present invention includes a camera that captures an image of an occupant of a vehicle, an image processor that processes the image of the occupant captured by the camera, and a position calculator that calculates a spatial position of a predetermined site of the occupant based on the image processed by the image processor. The camera is installed on a steering wheel of the vehicle away from a rotational shaft to be rotatable together with the steering wheel. The image processor processes two images captured by the camera at two different positions as the camera is rotated together with the steering wheel. The position calculator calculates the spatial position of the predetermined site of the occupant based on the two images processed by the image processor.

The occupant monitoring apparatus according to the above aspect includes the camera for capturing an image of the occupant installed on the steering wheel away from the rotational shaft. The camera, rotatable together with the steering wheel, can provide two images captured at two different positions. The two captured images are processed by the image processor to be used for calculating the spatial position of the predetermined site of the occupant. The occupant monitoring apparatus thus eliminates the use of multiple cameras or a dedicated optical system, and is simple and inexpensive.

In the apparatus according to the above aspect, the image processor may include a face detector that detects a face of the occupant from the images captured by the camera, and the position calculator may calculate a distance from the camera to a specific part of the face as a spatial position of the face.

In the apparatus according to the above aspect, the two images are, for example, a first captured image captured by the camera rotated by a first rotational angle to a first position and a second captured image captured by the camera rotated by a second rotational angle to a second position. In this case, the image processor generates a first rotated image by rotating the first captured image by a predetermined angle, and a second rotated image by rotating the second captured image by a predetermined angle. The position calculator calculates the spatial position of the predetermined site based on a baseline length that is a linear distance between the first position and the second position, a parallax obtained from the first rotated image and the second rotated image, and a focal length of the camera.

More specifically, the spatial position of the predetermined site may be calculated, for example, in the manner described below. The image processor generates the first rotated image by rotating the first captured image in a first direction by an angle |θ₂−θ₁|/2, and generates the second rotated image by rotating the second captured image in a second direction opposite to the first direction by an angle |θ₂−θ₁|/2. The position calculator calculates the baseline length as B=2·L·sin (182-811/2), and calculates the spatial position of the predetermined site as D=B·(f/δ). In the above expressions and formulas, L is a distance from the rotational shaft of the steering wheel to the camera, θ₁ is the first rotational angle, θ₂ is the second rotational angle, B is the baseline length, δ is the parallax, f is the focal length, and D is a distance from the camera to the predetermined site to define the spatial position of the predetermined site.

The apparatus according to the above aspect may further include a rotational angle detector that detects a rotational angle of the camera. The rotational angle detector may detect the first rotational angle and the second rotational angle based on the first captured image and the second captured image obtained from the camera.

In some embodiments, the rotational angle detector may detect the first rotational angle and the second rotational angle based on output from a posture sensor that detects a posture of the camera.

In some embodiments, the rotational angle detector may detect the first rotational angle and the second rotational angle based on output from a steering angle sensor that detects a steering angle of the steering wheel.

In the apparatus according to the above aspect, the position calculator may calculate the spatial position of the predetermined site based on the two images when the camera is rotated by at least a predetermined angle within a predetermined period between the two different positions.

### Advantageous Effects

The occupant monitoring apparatus according to the above aspect of the present invention detects the spatial position of a predetermined site of an occupant with a single camera.

### BRIEF DESCRIPTION OF THE DRAWINGS

FIG. 1 is a block diagram of an occupant monitoring apparatus according to a first embodiment of the present invention.

FIG. 2 is a plan view of a steering wheel on which a camera is installed.

FIG. 3 is a diagram describing monitoring of a driver by the camera.

FIGS. 4A to 4C are diagrams describing changes in the camera position as the steering wheel rotates.

FIGS. 5A to 5C are diagrams of images captured by the camera.

FIGS. 6A and 6B are diagrams of a first rotated image and a second rotated image.

FIG. 7 is a diagram of a captured image showing an eye area.

FIG. 8 is a diagram describing the principle for calculating a baseline length.

FIG. 9 is a diagram describing the principle for determining a distance based on stereo vision.

FIG. 10 is a flowchart showing an operation performed by the occupant monitoring apparatus.

FIG. 11 is a block diagram of an occupant monitoring apparatus according to a second embodiment of the present invention.

FIG. 12 is a block diagram of an occupant monitoring apparatus according to a third embodiment of the present invention.

FIG. 13 is a block diagram of an occupant monitoring apparatus according to a fourth embodiment of the present invention.

### DETAILED DESCRIPTION

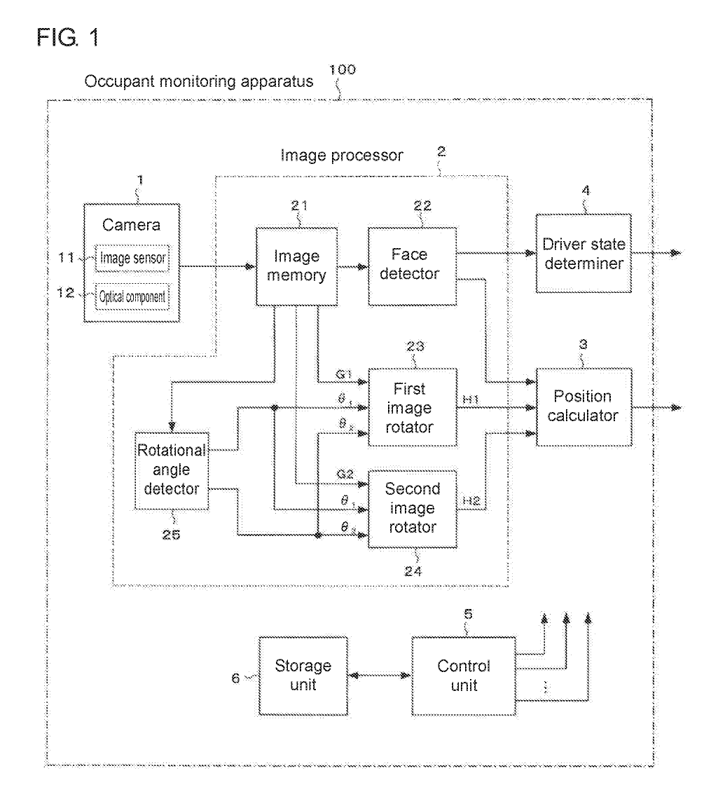

An occupant monitoring apparatus according to a first embodiment of the present invention will now be described with reference to the drawings. The structure of the occupant monitoring apparatus will be described first with reference to FIG. 1. In FIG. 1, an occupant monitoring apparatus 100, which is mounted on a vehicle, includes a camera 1, an image processor 2, a position calculator 3, a driver state determiner 4, a control unit 5, and a storage unit 6.

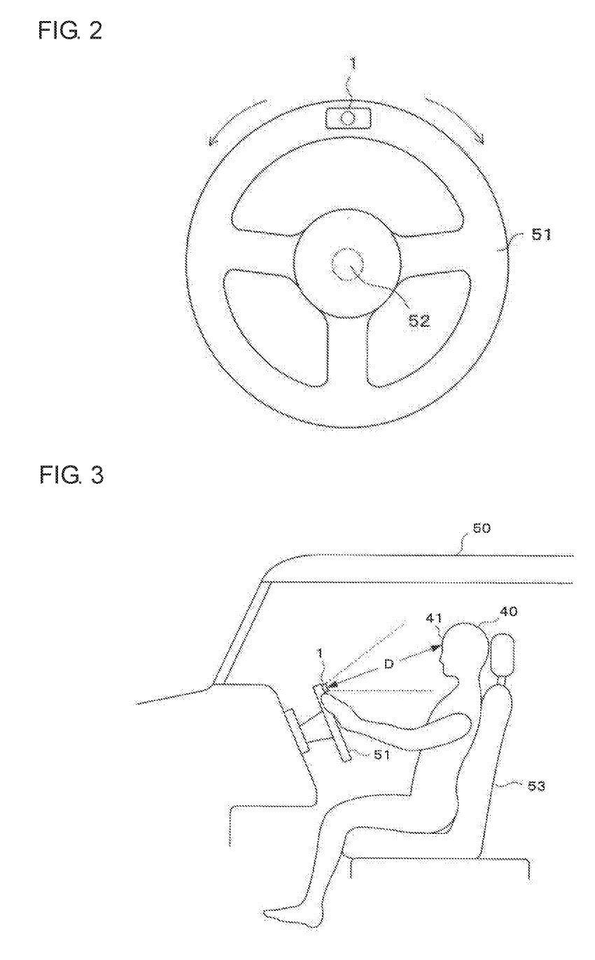

As shown in FIG. 2, the camera 1 is installed on a steering wheel 51 of the vehicle in a manner rotatable together with the steering wheel 51. The camera 1 is installed away from a rotational shaft 52 of the steering wheel 51. The camera 1 is rotated in the direction of the arrow about the rotational shaft 52 as the steering wheel 51 rotates. As shown in FIG. 1, the camera 1 includes an image sensor 11, such as a complementary metal-oxide semiconductor (CMOS) image sensor, and optical components 12 including a lens.

As shown in FIG. 3, the camera 1 captures an image of a face 41 of an occupant (driver) 40 seated in a driver seat 53 of a vehicle 50. The broken lines indicate an imaging range of the camera 1. A distance D is from the camera 1 to the face 41. As described later, the spatial position of the face 41 can be determined by using the distance D. The vehicle 50 is, for example, an automobile.

The image processor 2 includes an image memory 21, a face detector 22, a first image rotator 23, a second image rotator 24, and a rotational angle detector 25. The image memory 21 temporarily stores images captured by the camera 1. The face detector 22 detects the face of the driver from the image captured by the camera 1, and extracts feature points in the face (e.g., eyes). Methods for face detection and feature point extraction are known, and will not be described in detail.

The first image rotator 23 and the second image rotator 24 read images G1 and G2 (described later) captured by the camera 1 from the image memory 21, and rotate the captured images G1 and G2. The rotational angle detector 25 detects rotational angles θ₁ and θ₂ (described later) of the camera 1 based on the images captured by the camera 1 obtained from the image memory 21. The rotational angles θ₁ and θ₂ detected by the rotational angle detector 25 are provided to the first image rotator 23 and the second image rotator 24, and the first and second image rotators 23 and 24 then rotate the captured images G1 and G2 by predetermined angles based on the rotational angles θ1 and θ₂. This rotation of the images will be described in detail later.

The position calculator 3 calculates the distance D from the camera 1 to the face 41 shown in FIG. 3, or specifically the spatial position of the face 41, based on rotated images H1 and H2 (described later) generated by the first image rotator 23 and the second image rotator 24 and facial information (e.g., a face area and feature points) detected by the face detector 22. This will also be described in detail later. The output of the position calculator 3 is provided to an electronic control unit (ECU, not shown) incorporated in the vehicle through a Controller Area Network (CAN).

The driver state determiner 4 detects, for example, eyelid movements and a gaze direction based on the facial information obtained from the face detector 22, and determines the state of the driver 40 in accordance with the detection result. For example, when the eyelids are detected as being closed for longer than a predetermined duration, the driver 40 is determined to be falling asleep. When the gaze is detected as being aside, the driver 40 is determined to be engaging in distracted driving. The output of the driver state determiner 4 is provided to the ECU through the CAN.

The control unit 5, which includes a central processing unit (CPU), centrally controls the operation of the occupant monitoring apparatus 100. The control unit 5 is thus communicably connected to each unit included in the occupant monitoring apparatus 100 using signal lines (not shown). The control unit 5 also communicates with the ECU through the CAN.

The storage unit 6, which includes a semiconductor memory, stores, for example, programs for implementing the control unit 5 and associated control parameters. The storage unit 6 also includes a storage area for temporarily storing various data items.

The face detector 22, the first image rotator 23, the second image rotator 24, the rotational angle detector 25, the position calculator 3, and the driver state determiner 4 are each implemented by software, although they are shown as blocks in FIG. 1 for ease of explanation.

The principle for measuring the spatial position of the face with the occupant monitoring apparatus 100 will now be described.

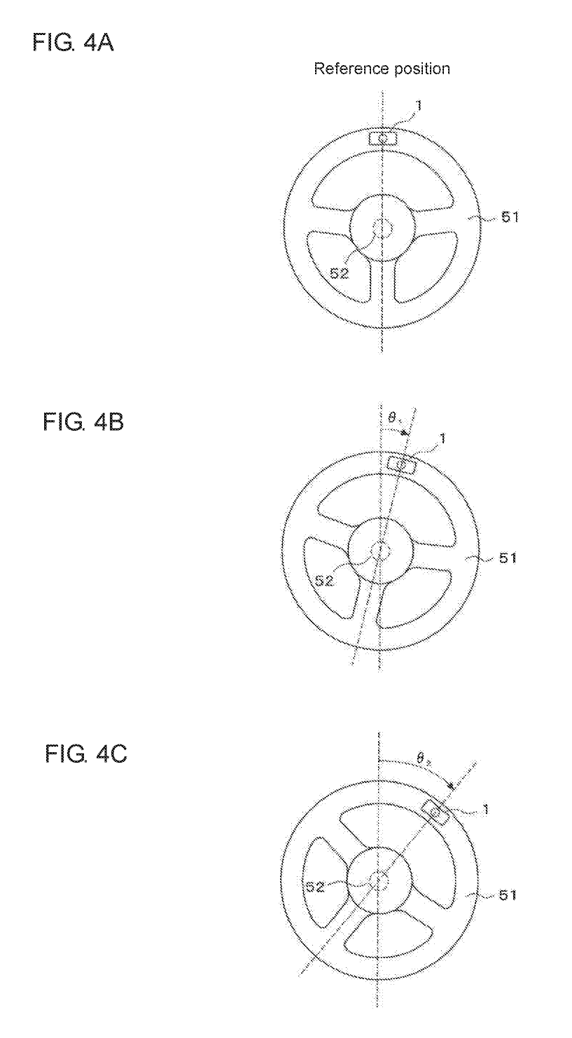

FIGS. 4A to 4C are diagrams describing changes in the position of the camera 1 that is rotated as the steering wheel 51 rotates. In FIG. 4A, the steering wheel 51 is at a reference position. In FIG. 4B, the steering wheel 51 rotates by an angle θ₁ from the reference position. In FIG. 4C, the steering wheel 51 further rotates by an angle θ₂ from the reference position. The position of the camera 1 in FIG. 4B corresponds to the first position of the claimed invention, and the position of the camera 1 in FIG. 4C corresponds to the second position of the claimed invention.

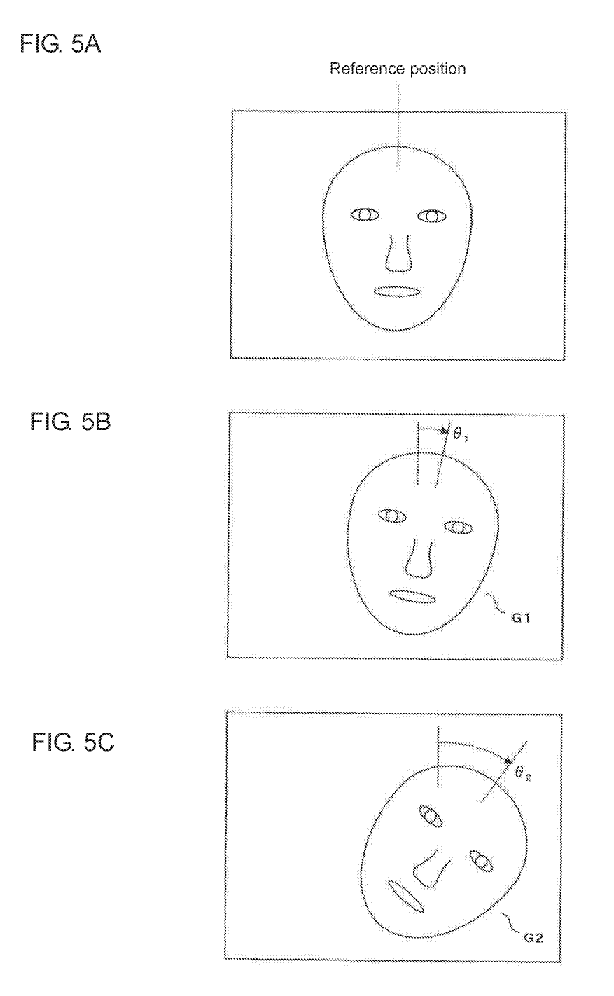

FIGS. 5A to 5C are diagrams of example images captured by the camera 1 at the positions shown in FIGS. 4A to 4C. For ease of explanation, the images of the face are simply shown without the background images.

FIG. 5A, which corresponds to FIG. 4A, shows an image captured by the camera 1 at the reference position. This is an erect image without inclination. FIG. 5B, which corresponds to FIG. 4B, shows the image G1 captured by the camera 1 rotated by the angle θ₁ from the reference position as the steering wheel 51 rotates by the angle θ₁. The angle θ₁ corresponds to the first rotational angle of the claimed invention, and the captured image G1 corresponds to the first captured image of the claimed invention. FIG. 5C, which corresponds to FIG. 4C, is the image G2 captured by the camera 1 rotated by the angle θ₂ from the reference position as the steering wheel 51 rotates by the angle θ₂. The angle θ₂ corresponds to the second rotational angle of the claimed invention, and the captured image G2 corresponds to the second captured image of the claimed invention.

As shown in FIGS. 5A to 5C, the camera 1, which is rotatable together with the steering wheel 51, captures images at different positions (rotational angles). The captured images have different inclinations, and thus show different positions on a screen.

The apparatus according to one or more embodiments of the present invention uses two images captured by the camera 1 at two different positions to calculate the distance D shown in FIG. 3. The single camera 1 is moved (rotated) to capture two images at different positions. The distance D is thus measured based on the same principle as a distance measured based on stereo vision using two cameras (described in detail later). The distance measurement using pseudo stereo vision created by moving a single camera is referred to as motion stereo.

The procedure for measuring a distance based on motion stereo performed by the apparatus according to one or more embodiments of the present invention will now be described. As described above, the camera 1 first captures two images at two different positions. The two images include the image G1 shown in FIG. 5B captured by the camera 1 at the rotational angle θ₁ shown in FIG. 4B, and the image G2 shown in FIG. 5C captured at the rotational angle θ₂ shown in FIG. 4C.

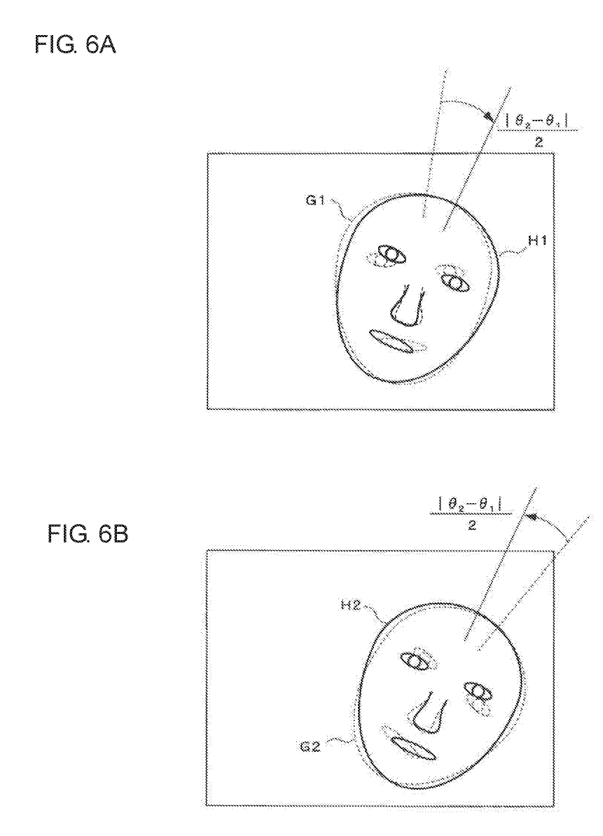

The two captured images G1 and G2 are then each rotated by a corresponding predetermined angle. More specifically, as shown in FIG. 6A, the captured image G1 is rotated clockwise by an angle |θ₂−θ₁|/2 to generate the rotated image H1 indicated by the solid lines. As shown in FIG. 6B, the captured image G2 is rotated counterclockwise by an angle |θ₂−θ₁|/2 to generate the rotated image H2 indicated by the solid lines. The rotated image H1 corresponds to the first rotated image of the claimed invention, and the rotated image H2 corresponds to the second rotated image of the claimed invention. The clockwise direction corresponds to the first direction of the claimed invention, and the counterclockwise direction corresponds to the second direction of the claimed invention.

The rotated image H1 is the captured image G1 rotated up to the mid-angle of the rotational angles between images G1 and G2. The rotated image H2 is also the captured image G2 rotated up to the mid-angle of the rotational angles between the images G1 and G2. The rotated images H1 and H2 thus have the same inclination on a screen. As described above, the captured images G1 and G2 are rotated in opposite directions by the angle |θ₂−θ₁|/2 to generate the two images H1 and H2 with the same posture, which can also be captured by a typical stereo camera.

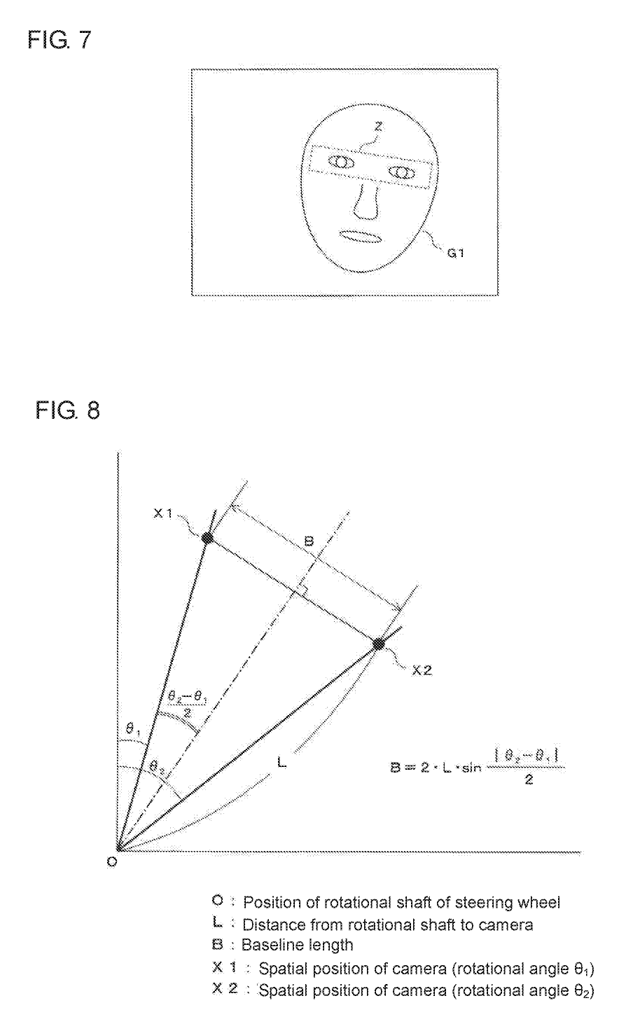

In the present embodiment, the captured images G1 and G2 are directly rotated to generate the rotated images H1 and H2. In some embodiments, as shown in FIG. 7, an eye area Z or another area cut out from the captured image G1 may be selectively rotated to generate a rotated image. The captured image G2 may be processed in the same manner.

The obtained rotated images H1 and H2 will now be used to determine the distance based on stereo vision. For the distance determination, a baseline length, which is the linear distance between two positions of the camera, will first be obtained. The baseline length will be described with reference to FIG. 8.

In FIG. 8, O indicates the position of the rotational shaft 52 of the steering wheel 51 (FIG. 2), X1 indicates the position of the camera 1 shown in FIG. 4B, X2 indicates the position of the camera 1 shown in FIG. 4C, and L indicates the distance from the rotational shaft 52 to the camera position X1 or X2. B indicates the linear distance between the camera positions X1 and X2, which is the baseline length. The baseline length B is geometrically calculated with the formula below with reference to FIG. 8.

B=2·L·sin(|θ₂−θ₁|/2) (1)

The distance L is known, and thus the baseline length B is obtained by detecting the angles θ₁ and θ₂. The angles θ₁ and θ₂ are detected from the captured images G1 and G2 in FIGS. 5B and 5C.

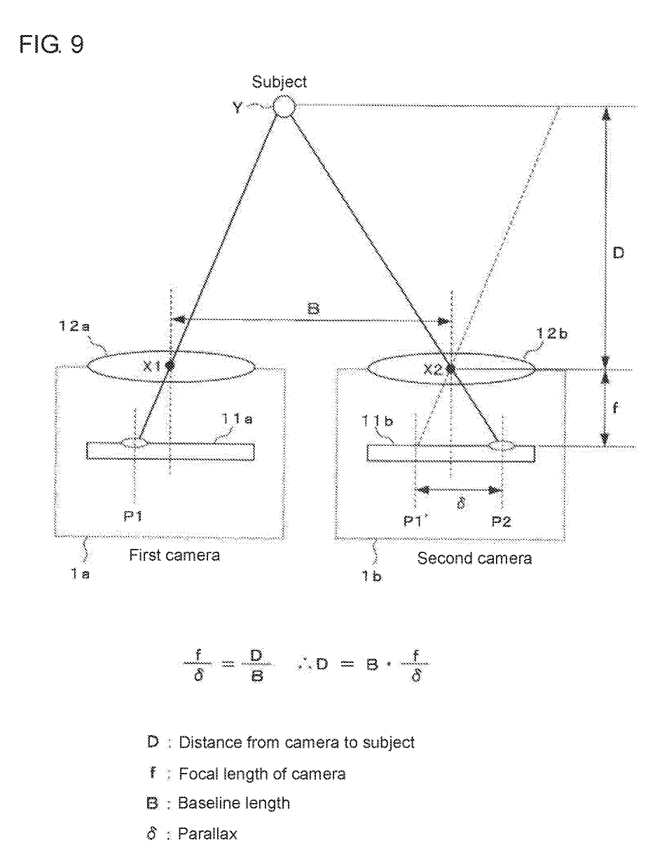

After obtaining the baseline length B, the distance from the camera 1 to a subject is determined in accordance with typical distance measurement based on stereo vision. The distance determination will be described in detail with reference to FIG. 9.

FIG. 9 is a diagram describing the principle for determining a distance based on stereo vision. The determination is based on the principle of triangulation. In FIG. 9, a stereo camera includes a first camera 1a including an image sensor 11a and a lens 12a and a second camera 1b including an image sensor 11b and a lens 12b. The first camera 1a corresponds to the camera 1 at the position X1 in FIG. 8. The second camera 1b corresponds to the camera 1 at the position X2 in FIG. 8. FIG. 9 shows the camera positions X1 and X2 in FIG. 8 as optical centers (centers of the lenses 12a and 12b) of the cameras 1a and 1b. The distance B between the optical centers X1 and X2 is the baseline length.

Images of a subject Y captured by the cameras 1a and 1b are formed on the imaging surfaces of the image sensors 11a and 11b. The images of the subject Y include images of a specific part of the subject Y formed at a position P1 on the imaging surface of the first camera 1a and at a position P2 on the imaging surface of the second camera 1b. The position P2 is shifted by a parallax δ from a position P1′, which corresponds to the position P1 for the first camera 1a. Geometrically, f/δ=D/B, where f indicates the focal length of each of the cameras 1a and 1b, and D indicates the distance from the camera 1a or 1b to the subject Y. The distance D is thus calculated with the formula below.

D=B·f/δ (2)

In the formula (2), the baseline length B is calculated with the formula (1). The focal length f is known. Thus, the distance D can be calculated by obtaining the parallax δ. The parallax δ may be obtained through known stereo matching. For example, the image captured by the second camera 1b is searched for an area having the same luminance distribution as a specific area in the image captured by the first camera 1a, and the difference between those two areas is obtained as the parallax.

The apparatus according to one or more embodiments of the present invention detects the parallax δ between the rotated images H1 and H2 in FIGS. 6A and 6B based on the principle described with reference to FIG. 9. In this case, the two rotated images H1 and H2, which have the same inclination (posture) as described above, easily undergo stereo matching. An area to undergo matching may be a specific part of the face 41 (e.g., the eyes). Using the parallax δ for the specific part, the distance D between the camera 1 and the specific part of the face 41 is calculated with the formula (2). The spatial position of the camera 1 depends on the rotational angle of the steering wheel 51. Thus, the distance D defined as the distance from the camera 1 to the face 41 is used to specify the spatial position of the face 41.

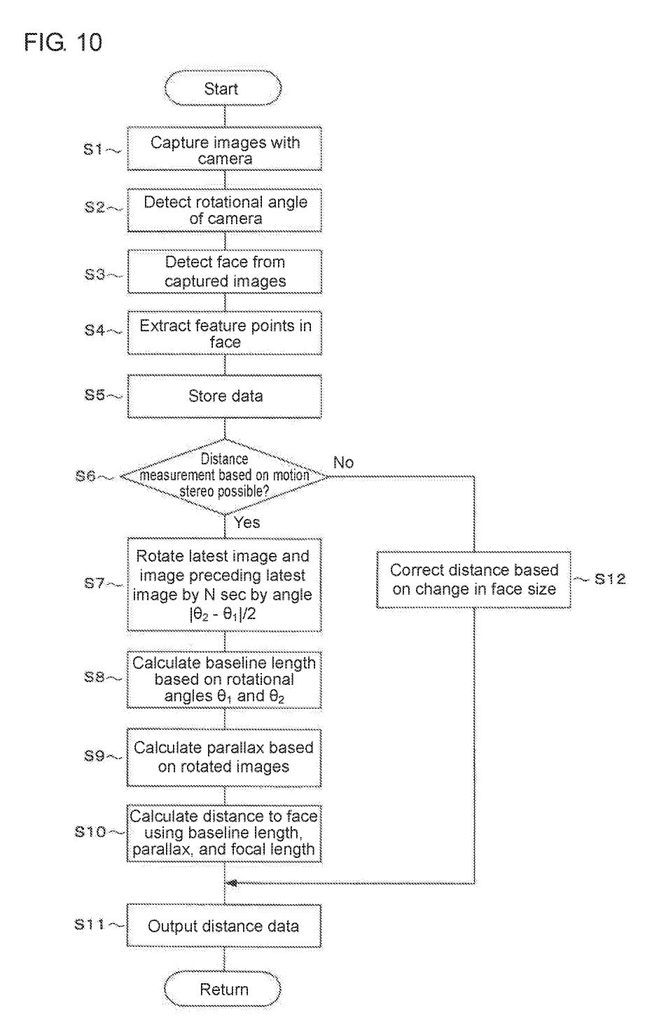

FIG. 10 is a flowchart showing an operation performed by the occupant monitoring apparatus 100. The steps in the flowchart are performed in accordance with the programs stored in the storage unit 6 under control by the control unit 5.

In step S1, the camera 1 captures images. The images captured by the camera 1 are stored into the image memory 21. In step S2, the rotational angle detector 25 detects the rotational angle of the camera 1 that is rotated together with the steering wheel 51 from the images G1 and G2 (FIGS. 5B and 5C) captured by the camera 1. In step S3, the face detector 22 detects a face from the images captured by the camera 1. In step S4, the face detector 22 extracts feature points (e.g., eyes) from the detected face. In step S5, data including the rotational angle, the face images, or the feature points obtained in steps S2 to S4 is stored into the storage unit 6. The face images and the feature points are stored in association with the rotational angle.

In step S6, the control unit 5 determines whether distance measurement based on motion stereo is possible using the data stored in step S5. Measuring the distance to a subject based on motion stereo uses images captured by the camera 1 at two positions that are apart from each other by at least a predetermined distance. Additionally, motion stereo uses two images capturing a subject with no movement. Thus, two images captured at a long time interval, which may capture a moving subject, can cause inaccurate distance measurement. In step S6, the control unit 5 thus determines that distance measurement based on motion stereo is possible when the camera 1 is rotated by at least a predetermined angle (e.g., at least an angle of 10°) within a predetermined period (e.g., five seconds) between two different positions. When the camera 1 is not rotated by at least the predetermined angle within the predetermined period, the control unit 5 determines that distance measurement based on motion stereo is not possible.

When distance measurement is determined possible in step S6 (Yes in step S6), the processing advances to step S7. In step S7, the image rotators 23 and 24 rotate the latest image and the image preceding the latest image by N seconds (N≤5) by the angle |θ₂−θ₁|/2, where |θ₂−θ₁|≥10°. For example, the captured image G1 in FIG. 5B is the image preceding the latest image by N seconds, and is rotated by the first image rotator 23 clockwise by the angle |θ₂−θ₁|/2 as shown in FIG. 6A. The captured image G2 in FIG. 5C is the latest image, and is rotated by the second image rotator 24 counterclockwise by the angle |θ₂−θ₁|/2 as shown in FIG. 6B.

In step S8, the position calculator 3 calculates the baseline length B with the formula (1) based on the rotational angles θ₁ and θ₂ obtained from the storage unit 6. In step S9, the position calculator 3 calculates the parallax δ based on the rotated images H1 and H2 (FIGS. 6A and 6B) generated by the image rotators 23 and 24. In step S10, the position calculator 3 calculates the distance D from the camera 1 to the face 41 with the formula (2) using the baseline length B calculated in step S8, the parallax δ calculated in step S9, and the known focal length f of the camera 1. In step S11, the distance data calculated in step S10 is output to the ECU through the CAN. The ECU uses this distance data to, for example, control the HUD described above.

When the distance measurement based on motion stereo is determined impossible in step S6 (No in step S6), the processing advances to step S12. In step S12, the distance D to the face is corrected based on the change in the size of the face in the captured images. More specifically, the distance in the image (the number of pixels) between any two feature points in the face is stored together with the distance D calculated in step S10 when the distance measurement based on motion stereo is possible (Yes in step S6). The two feature points are, for example, the centers of the two eyes. In step S12, the distance previously calculated in step S10 is corrected in accordance with the amount of change in the distance between the two feature points from the previous image to the current image. More specifically, when m is the distance (the number of pixels) between the feature points and Dx is the calculated distance to the face in the previous step S10, and n is the distance (the number of pixels) between the feature points in the current step S12, the current distance Dy to the face is calculated as Dy=Dx·(m/n), which is the corrected value for the distance to the face. For example, when m is 100 pixels, Dx is 40 cm, and n is 95 pixels, the corrected value for the distance is Dy=40 (cm)×100/95=42.1 (cm). As the face moves away from the camera 1 to reduce the size of the face in the image, the distance between the feature points on the image is reduced (n<m). This increases the calculated value for the distance from the camera 1 to the face (Dy>Dx).

The occupant monitoring apparatus according to the above embodiment includes the camera 1 installed on the steering wheel 51 away from the rotational shaft 52. The camera 1 rotatable together with the steering wheel 51 can thus provide two images G1 and G2 captured at two different positions. The apparatus then rotates the captured images G1 and G2 to generate the rotated images H1 and H2, and uses the parallax δ obtained from the rotated images H1 and H2 to calculate the distance D from the camera 1 to a specific part of the face 41 (the eyes in the above example). The occupant monitoring apparatus according to the above embodiment measures the spatial position of the face with a simple structure without multiple cameras or a dedicated optical system.

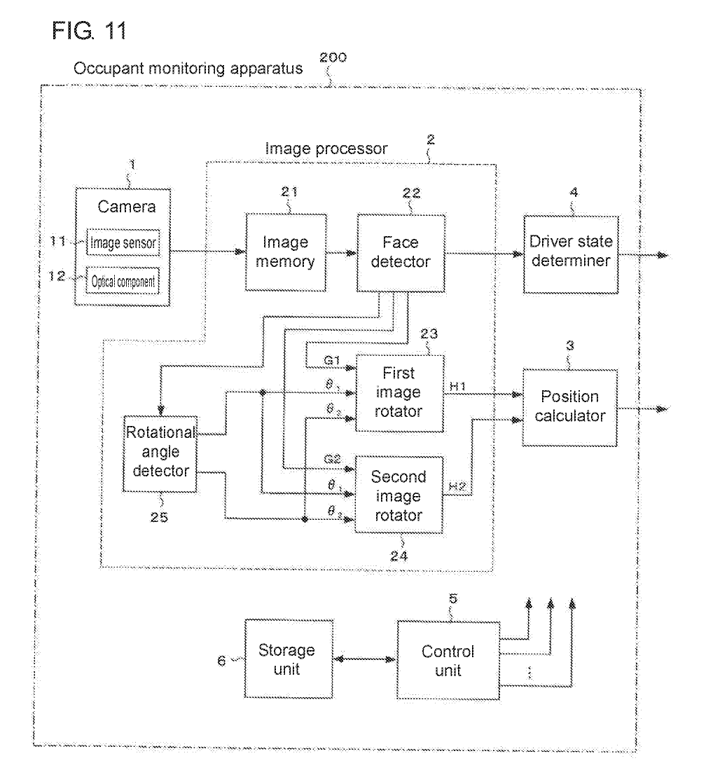

FIG. 11 is a block diagram of an occupant monitoring apparatus 200 according to a second embodiment of the present invention. In FIG. 11, the same components as in FIG. 1 are given the same reference numerals.

In the occupant monitoring apparatus 100 in FIG. 1, the rotational angle detector 25 detects the rotational angles θ₁ and θ₂ of the camera 1 based on images captured by the camera 1 (including images of the background in addition to images of the face) obtained from the image memory 21. In the occupant monitoring apparatus 200 in FIG. 11, the rotational angle detector 25 detects the rotational angles θ₁ and θ₂ of the camera 1 based on images of the face detected by the face detector 22. Also, the image rotators 23 and 24 rotate the images of the face detected by the face detector 22 to generate the rotated images H1 and H2. In this case, the rotated images H1 and H2 include facial information, which eliminates the operation of the position calculator 3 to obtain such information from the face detector 22.

The occupant monitoring apparatus 200 in FIG. 11 calculates the distance D from the camera 1 to the face 41 based on the same principle as used in the apparatus shown in FIG. 1.

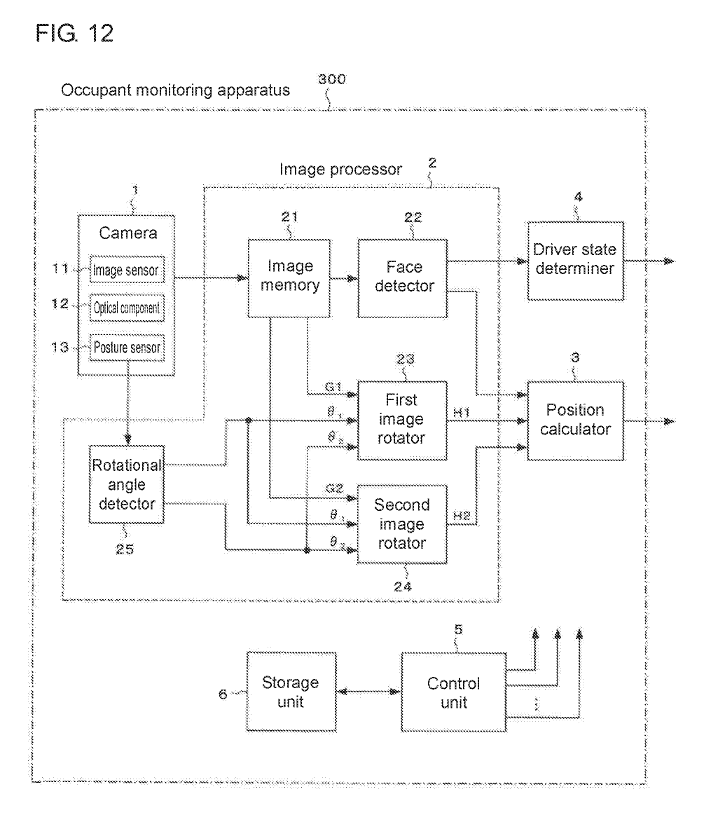

FIG. 12 is a block diagram of an occupant monitoring apparatus 300 according to a third embodiment of the present invention. In FIG. 12, the same components as in FIG. 1 are given the same reference numerals.

In the occupant monitoring apparatus 100 in FIG. 1, the rotational angle detector 25 detects the rotational angles θ₁ and θ₂ of the camera 1 based on images captured by the camera 1. In the occupant monitoring apparatus 300 in FIG. 12, the rotational angle detector 25 detects the rotational angles θ₁ and θ₂ of the camera 1 based on the output from a posture sensor 13 included in the camera 1. The posture sensor 13 may be, for example, a gyro sensor.

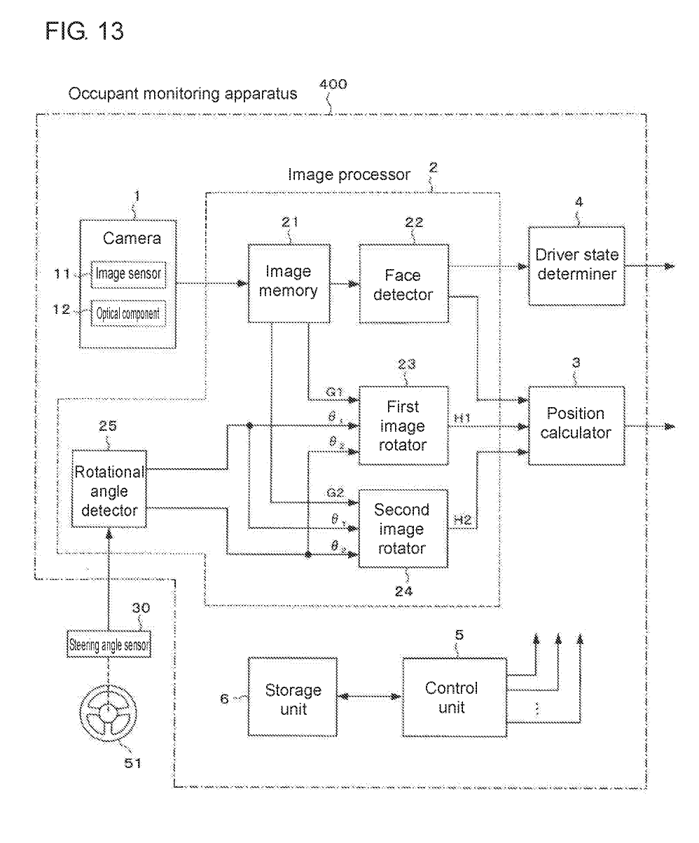

FIG. 13 is a block diagram of an occupant monitoring apparatus 400 according to a fourth embodiment of the present invention. In FIG. 13, the same components as in FIG. 1 are given the same reference numerals.

In the occupant monitoring apparatus 300 in FIG. 12, the rotational angle detector 25 detects the rotational angles θ₁ and θ₂ of the camera 1 based on the output from the posture sensor 13. In the occupant monitoring apparatus 400 in FIG. 13, the rotational angle detector 25 detects the rotational angles θ₁ and θ₂ of the camera 1 based on the output from a steering angle sensor 30 that detects the steering angle of the steering wheel 51. The steering angle sensor 30 may be, for example, a rotary encoder.

The occupant monitoring apparatuses 300 and 400 in FIGS. 12 and 13 calculate the distance D from the camera 1 to the face 41 based on the same principle as used in the apparatus shown in FIG. 1.

As in the apparatus in FIG. 11, the image rotators 23 and 24 in the apparatuses shown in FIGS. 12 and 13 may rotate the images of the face obtained from the face detector 22 to generate the rotated images H1 and H2.

In addition to the above embodiments, the present invention may be variously embodied in the manner described below.

In the above embodiments, the camera 1 is installed on the steering wheel 51 at the position shown in FIG. 2. In some embodiments, the camera 1 may be installed at any position on the steering wheel 51 away from the rotational shaft 52 other than at the position shown in FIG. 2.

In the above embodiments, the captured image G1 is rotated clockwise by the angle |θ₂−θ₁|/2, and the captured image G2 is rotated counterclockwise by the angle |θ₂−θ₁|/2 (FIGS. 6A and 6B). In some embodiments, the images may be rotated in a different manner. For example, the captured image G1 may be rotated clockwise by an angle |θ₂−θ₁| to generate an image having the same inclination as the captured image G2. In some other embodiments, the captured image G2 may be rotated counterclockwise by an angle |θ₂−θ₁| to generate an image having the same inclination as the captured image G1.

In the above embodiments, the distance D from the camera 1 to the face 41 is calculated based on the eyes as the specific part of the face 41. In some embodiments, the specific part may be other than the eyes, and may be the nose, mouth, ears, or eyebrows. The specific part is not limited to a feature point in the face, such as the eyes, nose, mouth, ears, or eyebrows, and may be any other point. The site to be the subject of the distance measurement according to one or more embodiments of the present invention is not limited to the face, and may be other parts such as the head and the neck.

In the above embodiments, the distance D from the camera 1 to the face 41 is defined as the spatial position of the face 41. In some embodiments, the spatial position may be defined by coordinates, rather than by the distance.

In the above embodiments, the occupant monitoring apparatuses 100 to 400 each include the driver state determiner 4. In some embodiments, the driver state determiner 4 may be external to the occupant monitoring apparatuses 100 to 400.

1. An occupant monitoring apparatus, comprising:
a camera configured to capture an image of an occupant of a vehicle;
an image processor configured to process the image of the occupant captured by the camera; and
a position calculator configured to calculate a spatial position of a predetermined site of the occupant based on the image processed by the image processor,
wherein the camera is installed on a steering wheel of the vehicle away from a rotational shaft to be rotatable together with the steering wheel,
the image processor processes two images captured by the camera at two different positions as the camera is rotated together with the steering wheel, and
the position calculator calculates the spatial position of the predetermined site based on the two images processed by the image processor.

2. The occupant monitoring apparatus according to claim 1, wherein
the image processor includes a face detector configured to detect a face of the occupant from the images captured by the camera, and
the position calculator calculates a distance from the camera to a specific part of the face as a spatial position of the face.

3. The occupant monitoring apparatus according to claim 1, wherein
the two images include a first captured image captured by the camera rotated by a first rotational angle to a first position and a second captured image captured by the camera rotated by a second rotational angle to a second position,
the image processor generates a first rotated image by rotating the first captured image by a predetermined angle, and a second rotated image by rotating the second captured image by a predetermined angle, and
the position calculator calculates the spatial position of the predetermined site based on a baseline length that is a linear distance between the first position and the second position, a parallax obtained from the first rotated image and the second rotated image, and a focal length of the camera.

4. The occupant monitoring apparatus according to claim 3, wherein
the image processor generates the first rotated image by rotating the first captured image in a first direction by an angle |θ₂−θ₁|/2, and generates the second rotated image by rotating the second captured image in a second direction opposite to the first direction by an angle |θ₂−θ₁|/2, and
the position calculator calculates the baseline length as B=2·L·sin (|θ₂−θ₁|/2), and calculates the spatial position of the predetermined site as D=B·(f/δ),
where L is a distance from the rotational shaft of the steering wheel to the camera, θ₁ is the first rotational angle, θ₂ is the second rotational angle, B is the baseline length, δ is the parallax, f is the focal length, and D is a distance from the camera to the predetermined site to define the spatial position of the predetermined site.

5. The occupant monitoring apparatus according to claim 3, further comprising:
a rotational angle detector configured to detect a rotational angle of the camera,
wherein the rotational angle detector detects the first rotational angle and the second rotational angle based on the first captured image and the second captured image obtained from the camera.

6. The occupant monitoring apparatus according to claim 3, further comprising:
a rotational angle detector configured to detect a rotational angle of the camera,
wherein the rotational angle detector detects the first rotational angle and the second rotational angle based on output from a posture sensor configured to detect a posture of the camera.

7. The occupant monitoring apparatus according to claim 3, further comprising:
a rotational angle detector configured to detect a rotational angle of the camera,
wherein the rotational angle detector detects the first rotational angle and the second rotational angle based on output from a steering angle sensor configured to detect a steering angle of the steering wheel.

8. The occupant monitoring apparatus according to claim 1, wherein
the position calculator calculates the spatial position of the predetermined site based on the two images when the camera is rotated by at least a predetermined angle within a predetermined period between the two different positions.
